(19) United States
(12) Patent Application Publication
(10) Pub. No.: US 2006/0093125 A1
(43) Pub. Date: May 4, 2006

(54) Messaging presence for non-messaging devices

(76) Inventor: Anthony J. Dezonno, Bloomingdale, IL (US)

Correspondence Address: Welsh & Katz, Ltd.;Jon P. Christensen, 22nd Floor, 120 South Riverside Plaza, Chicago, IL, 60606, US

(21) Appl. No.: 10/979,533

(22) Filed: Nov. 2, 2004

(51) Int. Cl. H04M 3/00; H04M 5/00

(52) U.S. Cl. 379/265.03

(57) ABSTRACT

A method and apparatus are described that provides status information within a communication system. The method includes the steps of providing a resource list in an instant messaging registration server for a registration entity, where said resource list includes a status indicator and system address for each resource within the resource list and where at least one resource of the resource list is a synchronous device, receiving a status registration message providing the status of the synchronous device for entry into the resource list and providing the resource list to a requesting entity.

### FIELD OF THE INVENTION

The field of the invention relates to communication systems and more particularly to automatic call distributors.

### BACKGROUND OF THE INVENTION

Automatic call distributors (ACDs) are known. Such systems are typically used by organizations to serve large numbers of callers. Typically, calls are directed to a common telephone number and distributed to agents based upon some criteria (e.g., agent idle time).

ACDs can typically process both inbound and outbound calls. Typically, a controller monitors a workload of its agents. Where a workload of received calls fall below some threshold value, the controller may begin to initiate outbound calls.

In addition to placing and distributing calls, an ACD may also identify and display documents on agent terminals as an aid to processing the calls. In the case of incoming calls, the calls may be received along with dialed number identification service (DNIS) and/or automatic number identification (ANI) information. ANI may be used to identify a caller at the same instant as the call is delivered to the ACD. The controller of the ACD may use the ANI information to retrieve and display customer records on a terminal of the agent selected to handle the call at the same instant that the call is delivered to the agent.

In addition, textual information may be displayed on a terminal of the agent that guides the agent through a sales presentation. DNIS information may be used to identify an intended call target and to select an appropriate sales presentation for use by the agent based upon the intended call target.

While automatic call distributors work relatively well, they are not particularly well suited to the Internet environment. Further, the processes that are used for handling switched circuit calls within the PSTN cannot be used within the Internet where processing elements may be widely separated. Because of the widely separated nature of Internet call processing, a need exits for a method of tracking system resources that is adaptable to the Internet environment.

### SUMMARY OF THE INVENTION

A method and apparatus are described that provides status information within a communication system. The method includes the steps of providing a resource list in an instant messaging registration server for a registration entity, where said resource list includes a status indicator and system address for each resource within the resource list and where at least one resource of the resource list is a synchronous device, receiving a status registration message providing the status of the synchronous device for entry into the resource list and providing the resource list to a requesting entity.

### BRIEF DESCRIPTION OF THE DRAWINGS

FIG. 1 is a block diagram of a system that provides status information about devices that are connected to a communication system under an illustrated embodiment of the invention; and

FIG. 2 is a block diagram of the system of FIG. 1 in a context of use.

### DETAILED DESCRIPTION OF AN ILLUSTRATED EMBODIMENT

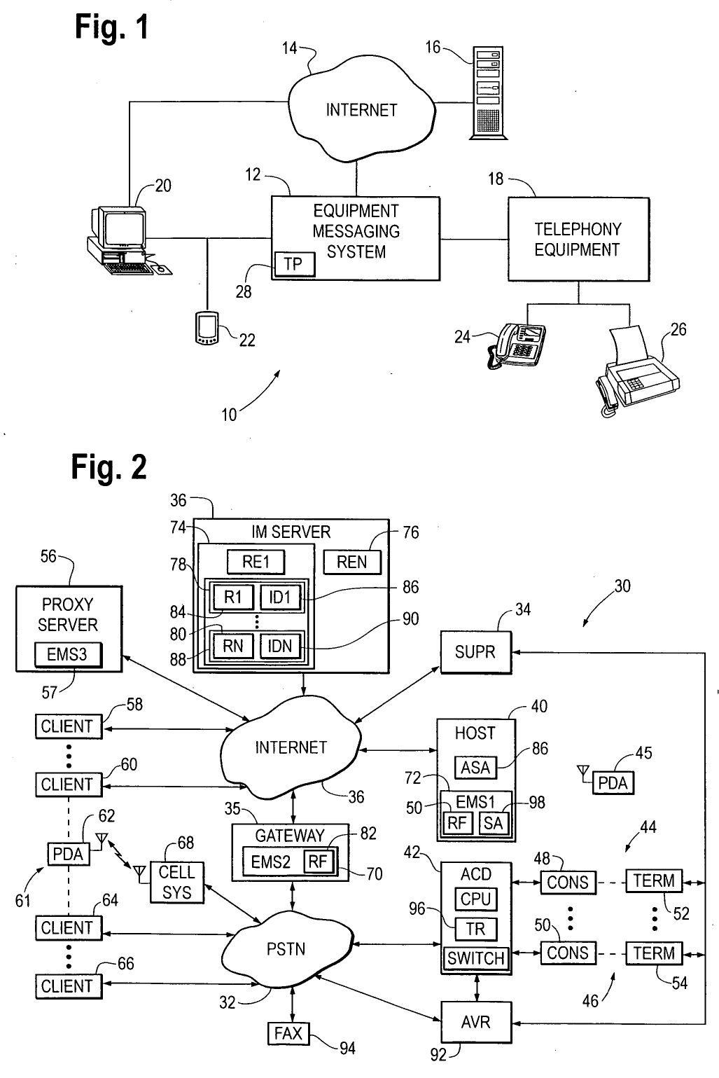

FIG. 1 is a block diagram of an Internet based tracking system 10 that provides status information about communication resources under illustrated embodiments of the invention. In effect, the system 10 provides a means by which instant message (IM) servers within the Internet may register (allow the appearance of) non-IM devices.

The ability to allow the appearance of a standard non-IM device as an alternative communication service with a secondary Im service has numerous advantages. In the past, only cellphones and computer displays could be part of the IM environment. Typically these devices are WAP and SMS enabled to allow for transmission under the closed protocol supported by the communications carrier to each of the devices. It is desirable for non-IM devices also to be seen in the IM open data management world as possible sources of communication to a user.

The system 10 may be used to track and provide status information about diverse communication devices that operate under a number of different communication protocols. Under illustrated embodiments, the tracking system 10 may track and report events regarding operation of one or more synchronous devices (e.g., POTS telephones, fax machines, voice response units, telephone switches, etc.) and asynchronous devices (e.g., computers, personal digital assistants (PDAs), etc.).

As used herein, a synchronous device is a device that relies upon a switched circuit, continuous connection for operation. An asynchronous device is a device that uses packets and packet switching.

The tracked events may be stored in an IM server under an identifier of a registration entity. The registration entity may be a human user or a processor subsystem, where the tracked events of the processor subsystem relate to communication resources provided by the processor subsystem. As used herein, a communication resource is a device that either provides cognizant information directly to a human user or that receives cognizant information directly from a human user.

In addition, the registration (IM) server may receive and save status information from a number of different resources of each registration entity. For example, a human user may have at his disposal a “plain old telephone service” (POTS) telephone, a personal digital assistant (PDA), a computer and a cell phone. Each of these devices may be registered in a resource list associated with the user. Under alternate embodiments, an attempt to access the user through the user's POTS telephone (where the POTS telephone has a status indication of unavailable) may cause a message to be sent to the user through another resource within the resource list.

In general, the resource list provides a convenient method of identifying and tracking the status of the resources of any particular registration entity. For example, if the registration entity is a voice response unit (VRU) of an automatic call distributor, then the resources in the resource list may be the individual voice channels that are available to callers through the VRU. In this particular case, a supervisor may monitor the status of the channels of the VRU by simply requesting the status of the registration entity (i.e., the VRU). In response, the IM server may display a status of each voice channel of the VRU on a terminal of the supervisor.

In use, the tracking and reporting systems 10 allows a user to identify a synchronous event about which the user wants information and to program the system 10 to accept status information about that event. The event may be a one-time event that results in a one-time collection of status information or the event may be a periodically occurring event that results in periodic collection of status information. The reported event may involve the action or availability of equipment or the actions of humans using the equipment.

In addition, the information within the instant message registration system may be used by the registering entity for the entity's own purposes or for the purposes of others. For example, a user may create a resource list that includes his POTS telephone and computer. Using the example above, the user may then create a processing routine based upon the status events of the resources in the resource list. The user may identify the status event to be the prior use of user's own POTS telephone at the same instant that a new call arrives. In this case, the user may program the system 10 to send an asynchronous message (IM) to the user's asynchronous device (the user's computer) notifying the user of the arrival of the new call along with the telephone number of the caller.

Turning now to the system 10, the system 10 (FIG. 1) may include an IM registration (presence) server 16 and an equipment messaging system 12. The IM presence server 16 may receive presence and status messages from the equipment messaging system 12. based upon the activities of any of a number of different devices 20, 22, 24, 26 within the system 10 through the Internet 14.

The equipment messaging system (status monitoring processor) 12 may interact and collect information from the telephony equipment 18 under any of a number of different formats. Under one illustrated embodiment, the equipment messaging system 12 and telephony equipment 18 may operate under Session Initiation Protocol (SIP) as defined by the Internet Engineering Task Force (IETF) RFP #3261. In this regard, the equipment messaging system 12 may be part of a feature set provided within a SIP proxy server as defined by IETF RFP #3261.

The equipment messaging system 12 and telephony equipment 18 may be part of the public network or part of a private network, such as an automatic call distributor (ACD). When used in an ACD, the system 10 may be used to track resources such as agent activity (e.g., agent log-in, log-out, etc.) or equipment availability (status).

Upon detecting a call answer or an availability signal (e.g., log-in, log-out, or configuration) from the telephony system 12, the messaging system 12 adds the terminal equipment as a resource to the users' list of available resources and changes the state of the user in the list to the current state of activity. It is desirable that an activity state be assigned to all devices along with a description of the device bandwidth for possible communication use. Devices that do not have a primary asynchronous data communication channel may have a secondary channel for communications so that this can be accomplished.

The system may also allow non-communication devices the ability to communicate over the messaging network in order to allow status measurement and control. In this event, the device is shown as a resource under the user identification and state information is sent to the equipment messaging system to update the current status of the system.

FIG. 2 is a block diagram of the status tracking and reporting system 10 set in a context of use under an illustrated embodiment of the invention. As shown in FIG. 2, equipment messaging systems 57, 70, 72 (similar to the equipment messaging system 12 of FIG. 1) may be provided at a number of convenient system access points (e.g., within the Internet to PSTN gateway 35, automatic call distributor (ACD) host 40, proxy server 56, etc.).

As a first illustration, a user (e.g., an agent 44 of the ACD 30) may have simultaneous access to a computer 52 and a POTS telephone 48. Using his computer 52, the agent 44 may log into an appropriate equipment messaging system 72. Logging in may be facilitated by provided a web site interface to the equipment messaging system 72 and by downloading interactive webpages to the terminal 52.

Upon downloading a webpage from the equipment messaging system 72, the agent 44 may use a utility of the system 72 to open a registering entity file 74, 76 within the instant messaging server 36. The agent 44 may also create a list of resources 78, 80 that corresponds to the communication devices 48, 52 available to the agent 44. Within each resource 78, 80, the user may enter a resource address and open a status field for the resource 78, 80.

For example, a first resource 78 may include an IM address 84 of the agent 44. The second resource 80 may include a PSTN system address (e.g., the telephone number) of the POTS telephone 48. The status indicators 86, 90 may be used as described below.

The user may also, optionally, create a routing file 90 within the equipment messaging system 72. The routing file 90 may be used to create a message processing routine based upon the contents of the resource file 74. For example, if a primary communication path is in use, then the routing file 84 may be used to compose and send a message over an alternate path using an alternate resource found within the resource list 74.

As another example, a supervisor 34 of the ACD system 30 may sign onto the equipment messaging system 72 and create an agent resource file 74. The supervisor 34, in this case, may wish to monitor the number of agents 44, 46 logged into the ACD system 30.

In this example, the supervisor 34 may proceed as described above. After logging into the equipment messaging system 72, the supervisor 34 may enter a list of universal resource locators (URLs) or universal resource identifiers (URIs) of respective agents of the ACD system 30.

In this regard, the ACD system 30 may require agents to sign into agent stations 44, 46 at a beginning of each shift. Before the agent 44 signs in, the status indicators of the resource list 74 may be listed as unavailable.

As each agent 44, 46 signs in, the URLs or URIs of the agents are detected by the equipment messaging system 72. As the equipment messaging system 72 detects the URL or URI of each agent 44, 46, the equipment messaging system 72 may send a message to the IM server 36 changing the status of the signed in agents from “unavailable” to “available”.

During a work shift, the supervisor 34 may periodically send a status inquiry to the IM server 36 regarding the agent resource list. The IM server 36 may respond with a list of agents signed in and agents not signed in.

Once an agent 44, 46 has signed in, the agent 44, 46 may begin receiving telephone calls. As telephone calls from clients 58, 64, 66 are received by the ACD 42, an agent selection application within a host of the ACD system 30 may select an agent 44, 46 qualified to answer the call and route the call to the agent 44, 46. As each call is assigned to the agent 44, the equipment messaging system 72 may change the status of the agent 44, 46 from available to unavailable.

If another call should arrive while the agent 44, 46 were handling another call, then the equipment selection application 72 may detect the unavailability of the agent telephone 48, 50. Detection of the unavailability of the primary synchronous resource may cause an alternate channel selection application 98 within the equipment messaging system 72 to search the resource table 36 for another available resource.

In this regard, the equipment messaging system 72 may determine that the IM resource is available and may proceed to route a message about the missed call to the agent 44, 46. In order to create the message, the equipment messaging system 72 may recover ANI information that identifies the caller of the missed call from the ACD 42. The ANI information may be encoded into the IM and forwarded to a terminal 52 of the agent. The IM may contain the words “You have missed a call from XXX-XXX-XXXX”.

At an end of each agent's shift, the agent may sign out of the ACD system 30. Alternatively, if the agent 44 were to remain on call, then the agent 44 may remain available for IMs through a PDA 45. In this case, if a telephone call should arrive at the ACD system 30 directed to the agent 44 (by direct inward dial (DID) or by direct assignment of the agent selection application 86, then the unavailability of the agent would still be detected by the equipment messaging system 72 and an IM may be forwarded accordingly. In this case, the equipment messaging system 72 may retrieve the resources list using the telephone number of the agent as an index.

Under another illustrated embodiment, the supervisor 34 may wish to monitor the status of an automatic voice response unit 92. As above, the supervisor 34 may access a webpage from the equipment messaging system 72 and open a file by entering an identifier (URL) of the AVR 92. The supervisor 34 may then open a resource list that includes each voice channel of the VRU 92. The resource list may include a sub-address of each voice channel and status indicator. The equipment messaging system 72 may periodically query the VRU 92 for the status of each channel or the VRU 92 may be provided with a subroutine to automatically collect and forward status information at regular intervals.

The supervisor 34 may periodically query the IM server 36 for AVR status. The AVR status may be provided in the form of the resource list with a status indicator adjacent the identifier of each voice channel.

As an alternative, it may be necessary to individually test each voice channel of the VRU 92 as well as other analog devices connected to the system. In this regard, after setting up the proper resource files, a test routine 96 may place calls to such devices as the voice channels of the VRU 92 and possible other devices (e.g., fax machine 94). The test routine 96 may measure proper operation by detecting the proper audible signals and responses and comparing the responses with threshold limits. The test routine 96 may then forward a status of each resource that is ultimately placed within the respective resource lists.

In another example, a first user 61 may have access to a POTS telephone 64, a PDA 62 and computer 60. The user may open a resource file 74, 76 listing each resource 60, 62, 64 within resource entries 78, 80 of the resource file.

Calls may be placed to the user 61 from another user 58 under a Session Initiation Protocol (SIP) as defined by the Internet Engineering Task Force RFC #3261. In this regard, the use 58 may compose a SIP INVITE (as defined by IETF RFC #3261) using a contact address to the proxy server 56. If the contact address is a telephone number of the user 61, then the SIP INVITE may be forwarded to the gateway 35. If the telephone 64 of the user is busy, then the equipment messaging system 57 may formulate an IM regarding the missed call and forward the message to a PDA 62 or computer 60 of the user 61 as described above.

A specific embodiment of method and apparatus for providing status information regarding the availability of resources of a computer system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of providing status information about resources within a communication system, such method comprising:
providing a resource list in an instant messaging registration server for a registration entity, where said resource list includes a status indicator and system address for each resource within the resource list and where at least one resource of the resource list is a synchronous device;
receiving a status registration message that includes status information about the synchronous device and that is entered into the resource list;
providing the resource list that includes the received status information to a requesting entity.

2. The method of providing status information as in claim 1 further comprising a status monitoring processor monitoring the synchronous device for changes in status and sending a status change message to the instant messaging registration server when a status change is detected.

3. The method of providing status information as in claim 1 wherein the synchronous device further comprises a POTS telephone, the system address includes a telephone number and the registration entity is a human user.

4. The method of providing status information as in claim 3 wherein a resource of the resource list further comprises an instant messaging device with an instant messaging address and an instant messaging status.

5. The method of providing status information as in claim 4 further comprising detecting the registration entity missing a second call on the POTS telephone because the registration entity was busy with a first call.

6. The method of providing status information as in claim 5 further comprising an equipment messaging system retrieving the resource list using the telephone number of the POTS telephone as an index.

7. The method of providing status information as in claim 6 further comprising the equipment messaging system retrieving an instant messaging status and address from the retrieved resource list as an alternate message path.

8. The method of providing status information as in claim 7 further comprising sending an instant message to the human user notifying the user of the missed call.

9. The method of providing status information as in claim 8 wherein the instant message further comprises a telephone number of the caller of the second call.

10. The method of providing status information as in claim 9 further comprising retrieving the telephone number of the caller of the second call from ANI information delivered along with the second call.

11. The method of providing status information as in claim 1 wherein the registration entity further comprises an automatic voice response unit.

12. The method of providing status information as in claim 11 wherein the resource list further comprises identifiers and status indicators of voice channels of the automatic voice recognition unit.

13. The method of providing status information as in claim 11 wherein the requesting entity is a human supervisor of the automatic voice response unit.

14. The method of providing status information as in claim 1 wherein the status registration is an agent of an automatic call distributor signing-in at a beginning of a shift.

15. A apparatus for providing status information about resources within a communication system, such apparatus comprising:
means for providing a resource list in an instant messaging registration server for a registration entity, where said resource list includes a status indicator and system address for each resource within the resource list and where at least one resource of the resource list is a synchronous device;
means for receiving a status registration message that includes status information about the synchronous device and that is entered into the resource list;
means for providing the resource list that includes the received status information to a requesting entity.

16. The apparatus for providing status information as in claim 15 further comprising means within a status monitoring processor for monitoring the synchronous device for changes in status and sending a status change message to the instant messaging registration server when a status change is detected.

17. The apparatus for providing status information as in claim 15 wherein the synchronous device further comprises a POTS telephone, the system address includes a telephone number and the registration entity is a human user.

18. The apparatus for providing status information as in claim 17 wherein a resource of the resource list further comprises an instant messaging device with an instant messaging address and an instant messaging status.

19. The apparatus for providing status information as in claim 18 further comprising means for detecting the registration entity missing a second call on the POTS telephone because the registration entity was busy with a first call.

20. The apparatus for providing status information as in claim 19 further comprising means within an equipment messaging system for retrieving the resource list using the telephone number of the POTS telephone as an index.

21. The apparatus for providing status information as in claim 20 further comprising means within the equipment messaging system for retrieving an instant messaging status and address from the retrieved resource list as an alternate message path.

22. The apparatus for providing status information as in claim 21 further comprising means for sending an instant message to the human user notifying the user of the missed call.

23. The apparatus for providing status information as in claim 22 wherein the instant message further comprises a telephone number of the caller of the second call.

24. The apparatus for providing status information as in claim 23 further comprising means for retrieving the telephone number of the caller of the second call from ANI information delivered along with the second call.

25. The apparatus for providing status information as in claim 15 wherein the registration entity further comprises an automatic voice response unit.

26. The apparatus for providing status information as in claim 25 wherein the resource list further comprises identifiers and status indicators of voice channels of the automatic voice recognition unit.

27. The apparatus for providing status information as in claim 25 wherein the requesting entity is a human supervisor of the automatic voice response unit.

28. The apparatus for providing status information as in claim 15 wherein the status registration is an agent of an automatic call distributor signing-in at a beginning of a shift.

29. A apparatus for providing status information about resources within a communication system, such apparatus comprising:
a resource list disposed within an instant messaging registration server provided by a registration entity, where said resource list includes a status indicator and system address for each resource within the resource list and where at least one resource of the resource list is a synchronous device;
a status registration message sent to the instant messaging server that includes status information about the synchronous device and that is entered into the resource list;
a requesting entity that requests the resource list that includes the received status information.

30. The apparatus for providing status information as in claim 29 further comprising a status monitoring processor that monitors the synchronous device for changes in status and sending a status change message to the instant messaging registration server when a status change is detected.

31. The apparatus for providing status information as in claim 29 wherein the synchronous device further comprises a POTS telephone, the system address includes a telephone number and the registration entity is a human user.

32. The apparatus for providing status information as in claim 31 wherein a resource of the resource list further comprises an instant messaging device with an instant messaging address and an instant messaging status.

33. The apparatus for providing status information as in claim 32 further comprising means for detecting the registration entity missing a second call on the POTS telephone because the registration entity was busy with a first call.

34. The apparatus for providing status information as in claim 33 further comprising an alternate channel selection application within an equipment messaging system for retrieving the resource list using the telephone number of the POTS telephone as an index.

35. The apparatus for providing status information as in claim 34 further comprising an instant messaging status and address that are retrieved from the retrieved resource list as an alternate message path.

36. The apparatus for providing status information as in claim 35 wherein the instant message further comprises a telephone number of the caller of the second call.

37. The apparatus for providing status information as in claim 29 wherein the registration entity further comprises an automatic voice response unit.

38. The apparatus for providing status information as in claim 37 wherein the resource list further comprises identifiers and status indicators of voice channels of the automatic voice recognition unit.

39. The apparatus for providing status information as in claim 37 wherein the requesting entity is a human supervisor of the automatic voice response unit.

40. The apparatus for providing status information as in claim 29 wherein the status registration is an agent of an automatic call distributor signing-in at a beginning of a shift.

41. A method of providing status information about resources within a communication system, such method comprising:
detecting a change of state of a synchronous communication device; and
logging the detected state of the synchronous communication device into an instant messaging registration server.

42. The method of providing status information as in claim 41 wherein the step of detecting the change in state further comprises placing a call to the synchronous communication device.

43. The method of providing status information as in claim 41 further comprising defining the synchronous communication device as being a voice response unit.

44. The method of providing status information as in claim 41 wherein the step of detecting the change in state further comprises monitoring a transaction link of an automatic call distributor.

45. The method of providing status information as in claim 44 further comprising detecting an agent logging into the automatic call distributor.

46. The method of providing status information as in claim 44 further comprising detecting an agent logging out of the automatic call distributor.

47. The method of providing status information as in claim 41 further comprising defining the synchronous communication device as being an analog telephone user placing a call.

48. The method of providing status information as in claim 47 wherein the detected change in state further comprises the analog telephone user placing a call.

49. The method of providing status information as in claim 48 wherein the step of the analog telephone user placing a call further comprises detecting another call to the analog telephone.

50. The method of providing status information as in claim 49 further comprising sending an instant message to an asynchronous device associated with the analog telephone notifying a user of the other call.
